(19) United States
(12) Patent Application Publication
(10) Pub. No.: US 2005/0086105 A1
(43) Pub. Date: Apr. 21, 2005

(54) Optimization of advertising campaigns on computer networks

(76) Inventors: Jeffrey A. McFadden, Hillsborough, CA (US); Scott G. Eagle, Menlo Park, CA (US); David L. Goulden, Redwood City, CA (US); Anthony G. Martin, Los Altos, CA (US)

Correspondence Address: OKAMOTO & BENEDICTO, LLP, P.O. BOX 641330, SAN JOSE, CA, 95164, US

(21) Appl. No.: 10/790,892

(22) Filed: Mar. 2, 2004

Related U.S. Application Data
(60) Provisional application No. 60/512,607, filed on Oct. 17, 2003.

(51) Int. Cl. G06F 17/60

(52) U.S. Cl. 705/14; 705/10

(57) ABSTRACT

In one embodiment, a method of optimizing an advertising campaign on a computer network includes the steps of delivering an advertisement to a client computer over a computer network, measuring an efficacy of the advertisement to generate a result, and changing a characteristic of the advertisement based on the result. The characteristic of the advertisement may be an aesthetic feature or a processing trigger, for example. The aesthetic feature may include the presentation vehicle used to display the advertisement, the artwork of the advertisement, and so on. The processing trigger may include rules on when to display the advertisement. The efficacy of the advertisement may be measured by determining its conversion rate or click-through rate, for example.

### CROSS-REFERENCE TO RELATED APPLICATION

This application claims the benefit of U.S. Provisional Application No. 60/512,607, entitled “OPTIMIZATION OF ADVERTISING CAMPAIGNS ON COMPUTER NETWORKS”, filed by Jeffrey A. McFadden, Scott G. Eagle, David L. Goulden, and Anthony G. Martin on Oct. 17, 2003, the disclosure of which is hereby incorporated by reference in its entirety.

### BACKGROUND OF THE INVENTION

1. Field of the Invention

The present invention relates generally to delivery of messages over computer networks, and more particularly but not exclusively to delivery of advertisements over the Internet.

2. Description of the Background Art

Large public computer networks, such as the Internet, allow advertisers to reach a worldwide audience twenty-four hours a day, seven days a week. This has made large public networks a cost-effective medium for marketing and selling products (e.g., goods and services). On the Internet, for example, advertising revenues allow companies to distribute free software or provide free access to websites. Needless to say, advertising helps fuel the Internet economy.

A company may advertise products in its own website. It may also advertise products in popular websites, such as search engines or portals. Regardless of whether a company chooses to run advertisements in its own or third-party website, an advertising campaign involves significant costs not just in running the campaign, but also in lost sales due to ineffective advertising. Thus, a technique for optimizing an advertising campaign is generally desirable.

### SUMMARY

In one embodiment, a method of optimizing an advertising campaign on a computer network includes the steps of delivering an advertisement to a client computer over a computer network, measuring an efficacy of the advertisement to generate a result, and changing a characteristic of the advertisement based on the result. The characteristic of the advertisement may be an aesthetic feature or a processing trigger, for example. The aesthetic feature may include the presentation vehicle used to display the advertisement, the artwork of the advertisement, and so on. The processing trigger may include rules on when to display the advertisement. The efficacy of the advertisement may be measured by determining its conversion rate or click-through rate, for example. In one embodiment, changes to advertisements are made until after a predetermined amount of time, a target optimization level is achieved, or all the advertisements for the advertising campaign have been tried and the most effective ones have been selected.

These and other features of the present invention will be readily apparent to persons of ordinary skill in the art upon reading the entirety of this disclosure, which includes the accompanying drawings and claims.

### DESCRIPTION OF THE DRAWINGS

FIG. 1 shows a schematic diagram of an example computer that may be used in embodiments of the present invention.

FIG. 2 shows a schematic diagram of a computing environment in accordance with an embodiment of the present invention.

FIG. 3 shows a schematic diagram of a data packet in accordance with an embodiment of the present invention.

FIG. 4 shows a schematic diagram of a message unit in accordance with an embodiment of the present invention.

FIG. 5 shows a flow diagram of a method of optimizing an advertising campaign on a computer network in accordance with an embodiment of the present invention.

The use of the same reference label in different drawings indicates the same or like components.

### DETAILED DESCRIPTION

In the present disclosure, numerous specific details are provided such as examples of apparatus, components, and methods to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

The present disclosure discusses monitoring for triggering events and end-user browsing activities. Such monitoring are also disclosed in commonly-assigned U.S. application Ser. No. 10/152,204, filed on May 21, 2002 by Scott G. Eagle, David L. Goulden, Anthony G. Martin, and Eugene A. Veteska, which is incorporated herein by reference in its entirety.

Being computer-related, it can be appreciated that the components disclosed herein may be implemented in hardware, software, or a combination of hardware and software (e.g., firmware). Software components may be in the form of computer-readable program code stored in a computer-readable storage medium such as memory, mass storage device, or removable storage device. For example, a computer-readable medium may comprise computer-readable code for performing the function of a particular component. Likewise, computer memory may be configured to include one or more components, which may then be executed by a processor. Components may be implemented separately in multiple modules or together in a single module.

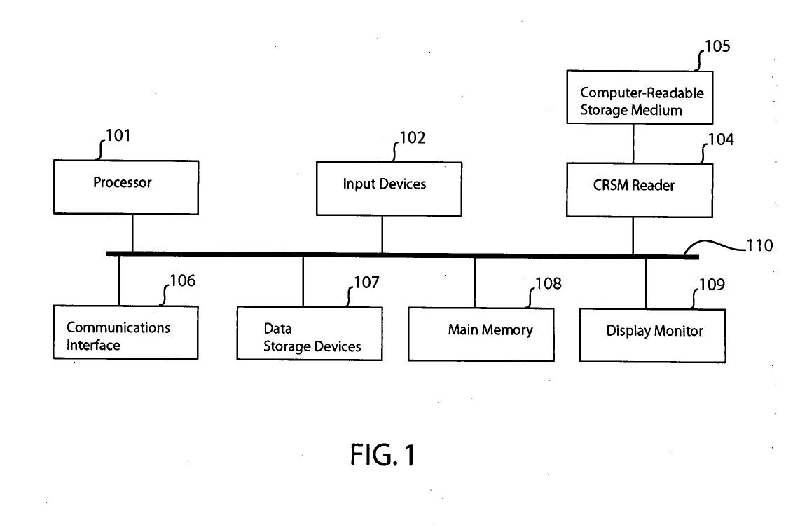

Referring now to FIG. 1, there is shown a schematic diagram of an example computer that may be used in embodiments of the present invention. Depending on its configuration, the computer shown in the example of FIG. 1 may be employed as a client computer, a server computer, a personal digital assistant, a digital phone, or other data processing device. The computer of FIG. 1 may have less or more components to meet the needs of a particular application. As shown in FIG. 1, the computer may include a processor 101, such as those from the Intel Corporation or Advanced Micro Devices, for example. The computer may have one or more buses 110 coupling its various components. The computer may include one ore more input devices 102 (e.g., keyboard, mouse), a computer-readable storage medium (CRSM) 105 (e.g., floppy disk, CD-ROM), a CRSM reader 104 (e.g., floppy drive, CD-ROM drive), a display monitor 109 (e.g., cathode ray tube, flat panel display), a communications interface 106 (e.g., network adapter, modem) for coupling to a network, one or more data storage devices 107 (e.g., hard disk drive, optical drive, FLASH memory), and a main memory 108 (e.g., RAM). Software embodiments may be stored in a computer-readable storage medium 105 for reading into a data storage device 107 or main memory 108. Software embodiments in main memory 108 may be executed by processor 101.

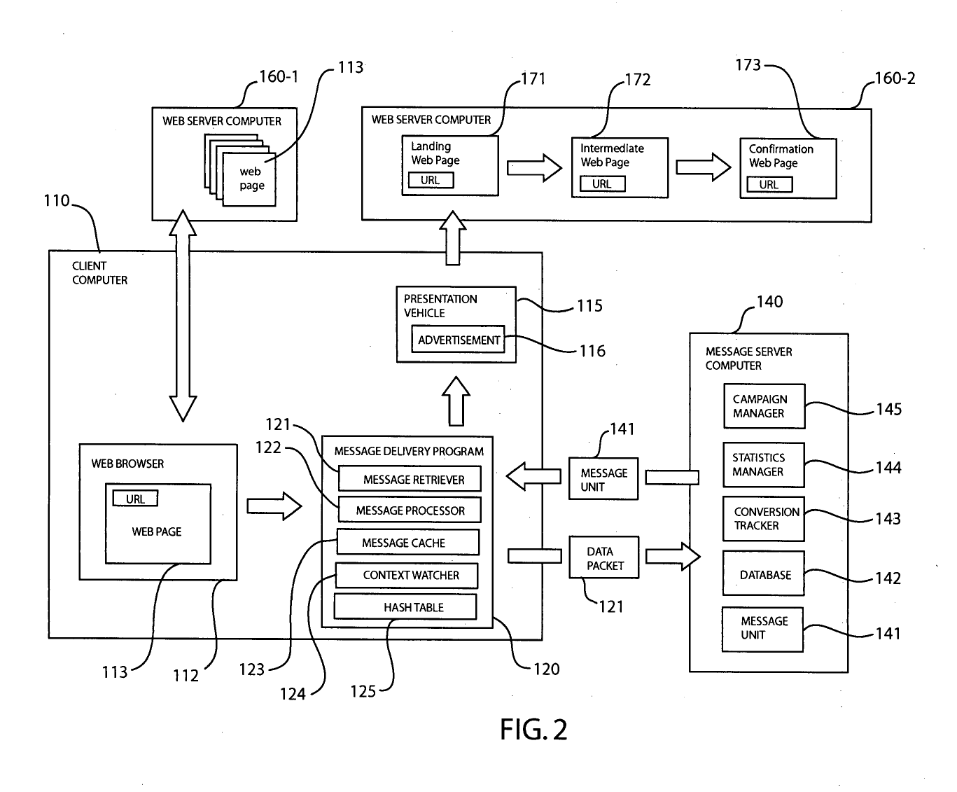

FIG. 2 shows a schematic diagram of a computing environment in accordance with an embodiment of the present invention. In the example of FIG. 2, the computing environment includes one or more web server computers 160 (i.e., 160-1, 160-2), one or more client computers 110, one or more message server computers 140, and other computers not specifically shown. In the example of FIG. 2, a client computer 110 communicates with server computers (e.g., a web server computer or a message server computer) over the Internet. Embodiments of the present invention may also be employed on computer networks other than the Internet. Intermediate nodes such as gateways, routers, bridges, Internet service provider networks, public-switched telephone networks, proxy servers, firewalls, and other network components are not shown for clarity.

A client computer 110 is typically, but not necessarily, a personal computer such as those running the Microsoft Windows™ operating system, for example. An end-user may employ a suitably equipped client computer 11 0 to get on the Internet and access computers coupled thereto. For example, a client computer 110 may be used to access web pages from a web server computer 160.

A web server computer 160 may be a website containing information designed to attract end-users surfing on the Internet. A web server computer 160 may also include advertisements, downloadable computer programs, a search engine and products available for online purchase. A web server computer 160 may also be an ad server for delivering advertisements to a client computer 110.

A message server computer 140 may include the functionalities of a web server computer 160. Additionally, in one embodiment, a message server computer 140 may also include one or more message units 141 for delivery to a client computer 110. A message unit 141 may contain advertisements, for example. Message units are further described below. A message server computer 140 may also include downloadable computer programs and files for supporting, updating, or maintaining components on a client computer 110.

Web server computers 160 and message server computers 140 are typically, but not necessarily, server computers such as those available from Sun Microsystems, Hewlett-Packard, or International Business Machines. A client computer 110 may communicate with a web server computer 160 or a message server computer 140 using client-server protocol. It is to be noted that client-server computing is well known in the art and will not be further described here.

As shown in FIG. 2, a client computer 110 may include a web browser 112 and a message delivery program 120. Web browser 112 may be a commercially available web browser or web client. In one embodiment, web browser 112 comprises the Microsoft Internet Explorer™ web browser. Using web browser 112, an end-user on client computer 110 may access a web page from a web server computer 160. That is, web browser 112 may be employed to receive a web page from a web server computer 160. In the example of FIG. 2, web browser 112 is depicted as displaying a web page 113 of web server computer 160-1. A web page, such as web page 113, has a corresponding address referred to as a “URL” (Uniform Resource Locator). Web browser 112 is pointed to the URL of a web page to receive that web page in client computer 110. Web browser 112 may be pointed to a URL by entering the URL at an address window of web browser 112, or by clicking on a hyperlink pointed to that URL, for example.

In one embodiment, message delivery program 120 is downloadable from a message server computer 140 or a web server computer 160. Message delivery program 120 may be downloaded to client computer 110 in conjunction with the downloading of another computer program. For example, message delivery program 120 may be downloaded to client computer 110 along with a utility program (not shown) that is provided free of charge or at a reduced cost. The utility program may be provided to an end-user in exchange for the right to deliver advertisements to client computer 110 via message delivery program 120. In essence, revenue from advertisements delivered to the end-user helps defray the cost of creating and maintaining the utility program.

Still referring to FIG. 2, message delivery program 120 may include a message retriever 121, a message processor 122, a message cache 123, a context watcher 124, and a hash table 125. In one embodiment, message delivery program 120 is a client program in that it is stored and run in a client computer 110.

Message retriever 121 may comprise computer-readable program code for monitoring an end-user browsing activity and for requesting message units 141 from message server computer 140. It is to be noted that the mechanics of monitoring an end-user's browsing activity, such as determining where an end-user is navigating to, what an end-user is typing on a web page, whether an end-user clicked on an advertisement, when an end-user activates a mouse or keyboard, and the like, is, in general, known in the art and is not further described here. For example, message retriever 121 may learn of end-user browsing activities by receiving event notifications from web browser 112.

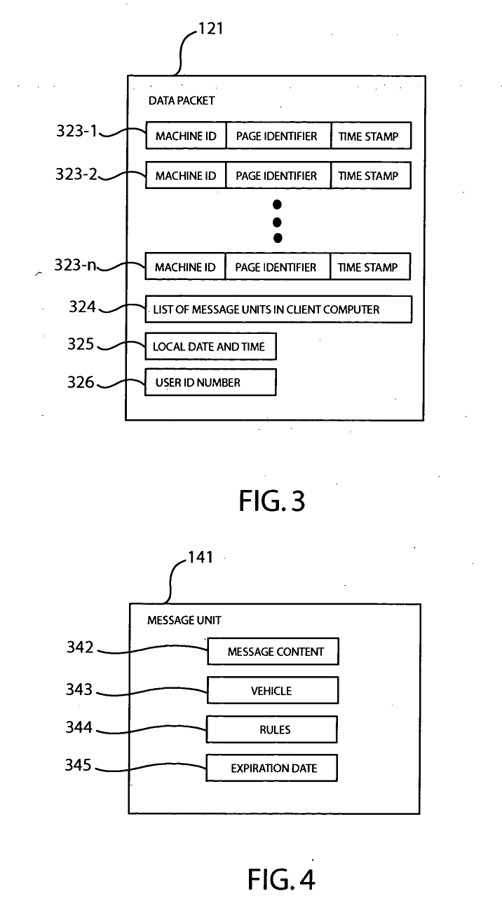

Message retriever 121 monitors web browser 112 for the uniform resource locator (URL) of web pages viewed by an end-user surfing on the Internet. For each domain visited by an end-user, message retriever 121 may send a data packet 121 to message server computer 140. As shown in FIG. 3, a data packet 121 may include one or more log entries 323 (i.e., 323-1, 323-2, . . . ), a message unit list 324, a local date and time 325, and a user ID number 326. In one embodiment, a data packet 121 does not include personally identifiable information to protect the end-user's privacy.

A log entry 323 contains data indicative of an end-user navigation to particular web sites to receive particular web pages. In one embodiment, a log entry 323 includes a machine ID identifying the client computer 110 where the log entry was made, a page identifier (e.g., a URL) identifying a web page viewed by an end-user, and a time stamp indicating when the web page was received in the client computer 110. For example, a log entry 323 may be created by message retriever 121 when the end-user navigates to a web page by entering the URL of that web page in the address window of web browser 11.2. As another example, message retriever 121 may generate a log entry 323 when the end-user clicks on a hyperlink of an advertisement 116 displayed in presentation vehicle 115, thereby pointing web browser 112 to a web page 171 of a web server computer 160-2. In that case, the URL of web page 171 will be identified in a page identifier field of the corresponding log entry 323. This allows for detection of whether the end-user responded to the advertisement 116 by clicking on it.

As is evident from the foregoing, log entries 323 document the navigation history of the end-user. Log entries 323 may thus be advantageously employed to deliver targeted advertisements because they are indicative of the end-user's on-line behavior. Furthermore, using a client program, such as message delivery program 120, to generate log entries 323 is advantageous because it allows for better documentation of end-user navigation history compared to server-based embodiments. More specifically, message retriever 121 may be configured to monitor end-user navigation to any website, not just selected websites.

A data packet 121 may also include a message unit list 324 containing a list of message units 141 stored in a message cache 123 of client computer 110. Message server computer 140 may examine message unit list 324 to prevent sending multiple copies of the same message unit to client computer 110. A local date and time 325 indicates when the data packet 121 was sent from client computer 110. A user ID number 326 anonymously identifies the end-user of the client computer 110. Additional information may also be added to a data packet 121, including data directly indicating when a particular advertisement was clicked on, keywords the end-user used to perform a search, and so on.

Message server computer 140 checks if there is a corresponding message unit 141 for each data packet 121 received from client computer 110. If so, message server computer 140 sends the corresponding message unit 141 to client computer 110. For example, message retriever 121 may send a data packet 121 to message server computer 140 as the end-user navigates from “storekeeper.com” to “cars.com.” If a message unit 141 is available for the domain “cars.com”, message server computer 140 may send that message unit 141 to client computer 110. Message cache 123 serves as a repository for message units 141 received from message server computer 140.

Client computer 110 may also include a hash table 125. Hash table 125 may contain information for determining whether a message unit 141 is available for a particular domain. This allows message retriever 121 to first query hash table 125 before sending a data packet 121 to message server computer 140. If hash table 125 indicates that there is a message unit 141 for a domain visited by the end-user, message retriever 121 may proceed to send a data packet i21 to message server computer 140. Otherwise, message retriever 121 may not send a data packet 121, thereby minimizing the amount of data packets sent to and processed by message server computer 140.

Message processor 122 may include computer-readable program code for processing a message unit 141. Message processor 122 may process a message unit 141 by displaying its message content. Message processor 122 may display a message content using a variety of presentation vehicles including pop-ups, pop-unders, banners, message boxes, text boxes, sliders, separate windows, windows embedded in a web page, and other mechanisms for displaying information. Message processor 122 may also process a message unit 141 by playing its message content if the message content is audio or video, or by running its message content if the message content is computer-readable program code, for example. As an example, message processor 122 may process a message unit by displaying a presentation vehicle that is configured to receive an advertisement from an ad server.

Context watcher 124 may comprise computer-readable program code for determining if a message unit 141 has been triggered for processing. Context watcher 124 checks message cache 123 for message units 141 whose rules have been satisfied. If context watcher 124 finds such a message unit 141, context watcher 124 alerts message processor 122 to process that message unit. Rules and processing triggers are further described below.

A message server computer 140 may include a plurality of message units 141, a database 142, a conversion tracker 143, a statistics manager 144, and a campaign manager 145.

Referring to FIG. 4, a message unit 141 may include a message content 342, a vehicle 343, rules 344, and an expiration date 345. Message content 342 may include computer-readable program code, text, images, audio, video, hyperlink, and other information. A message content 342 may be an advertisement or computer-readable program code for receiving an advertisement to be displayed on a computer screen, for example.

Vehicle 343 indicates the presentation vehicle to be used in presenting the message content indicated by message content 342. For example, vehicle 343 may call for the use of a pop-up, banner, message box, text box, slider, separate window, window embedded in a web page, or other presentation vehicle to display a message content.

Rules 344 indicate one or more triggering conditions for processing a message unit 141. Rules 344 may indicate when to process the message unit 141. Rules 344 may specify to display a message content 342 when an end-user navigates to a specific web page or as soon as the message unit 141 is received in a client computer 110. For example, a car company may contract with the operator of a message server computer 140 to deliver a message unit 141 containing an advertisement for a minivan (hereinafter, “minivan message unit”). The rules 344 of the minivan message unit may specify that the minivan advertisement is to be displayed to end-users viewing the minivan web page of “cars.com”. In this example, the minivan web page of cars.com has the URL “www.cars.com/minivans”. When an end-user visits the main page (or any web page) of “cars.com”, message retriever 121 (see FIG. 2) will send a data packet 121 to message server computer 140 indicating that the end-user is on “cars.com”. In response, message server computer 140 will send the minivan message unit to client computer 110. When the end-user navigates to the URL “www.cars.com/minivans”, context watcher 124 will detect that the minivan message unit has been triggered for processing (i.e., rules 344 of the minivan message Unit have been satisfied). Accordingly, context watcher 124 will inform message processor 122 that the message content 342 of the minivan message unit may be displayed.

Rules 344 may also include: (a) a list of domain names at which the content of a message unit 141 is to be displayed, (b) URL sub-strings that will trigger displaying of the content of the message unit 141, and (b) time and date information. As can be appreciated, rules 344 may also be extended to take into account additional information relating to an end-user (anonymously identified by a corresponding user ID number) such as the end-user's frequent flyer affiliation, club memberships, type of credit card used, hobbies and interests, and basic demographic information. End-user related information may be stored in client computer 110 or database 142 of message server computer 140. End-user related information may be used for targeted advertising purposes, for example.

As shown in FIG. 4, a message unit 141 may also include an expiration date 345. Expiration date 345 indicates the latest date and time the message unit 141 can still be displayed. In one embodiment, expired message units 141 are not displayed even if their respective rules 344 have been satisfied. Expired message units 141 may be removed from client computer 110.

Turning back to FIG. 2, message server computer 140 may include a database 142. Database 142 may be a commercially available database program. Database 142 may be employed to keep track of available message units 141 in message server computer 140. For example, message server computer 140 may query database 142 for all message units 141 available for a particular domain.

Database 142 may also include a translation table for storing a sequence of steps (also referred to as “conversion steps”) an end-user undertakes to convert an interaction with an advertisement. For example, the translation table may store a sequence of web pages that an end-user needs to navigate through to convert a clicking of an advertisement into a purchase. In the example of FIG. 2, an end-user who interacted with advertisement 116 by clicking on it will be forwarded to a landing web page 171 of web server computer 160-2. Landing web page 171 may be a first of a series of web pages allowing for the purchase of the advertised product. The series of web pages may include one or more intermediate web pages 172, and culminating in a confirmation web page 173. For example, intermediate web pages 172 may be checkout pages, while confirmation web page 173 may be the web page displayed after the end-user has gone through the checkout. In that example, the URLs of web pages 171, 172, and 173 comprise conversion steps for advertisement 116, and may be stored in database 142 for comparison with log entries 323 of one or more data packets 121. Database 142 may maintain a navigation history for each end-user to determine if the end-user has gone through all the conversion steps of an advertisement. The navigation history may be based on log entries 323 of received data packets 121. Database 142 may also include additional tables for decoding page identifiers (e.g., URL), and for storing statistical and tracking related information.

A conversion tracker 143 may comprise computer-readable program code for determining if an end-user has converted an interaction with an advertisement. In one embodiment, conversion tracker 143 performs its function by comparing log entries 323 of data packets 121 with conversion steps stored in database 142. This allows conversion tracker 143 to determine if an end-user has viewed the web pages necessary to complete the purchase of an advertised product, indicating that the advertisement delivered to the end-user has been converted into a purchase.

Statistics manager 144 may comprise computer-readable program code for generating statistical information. Examples of statistical information that may be generated by statistics manager 144 include, without limitation, pages viewed or not viewed by end-users, percentage of end-users that converted an interaction with an advertisement into a purchase, number of interactions with a particular advertisement displayed in a particular website, number of times an advertisement is displayed, click through rate of an advertisement, etc. Statistics manager 144 may generate statistical information based on data packets 121 received from client computers 110, data from conversion tracker 143, and other data sources.

Conversion tracking techniques are also disclosed in commonly-assigned U.S. application Ser. No. 10/464,419, entitled “GENERATION OF STATISTICAL INFORMATION IN A COMPUTER NETWORK,” filed by David L. Goulden and Dominic Bennett on Jun. 17, 2003, which is incorporated herein by reference in its entirety.

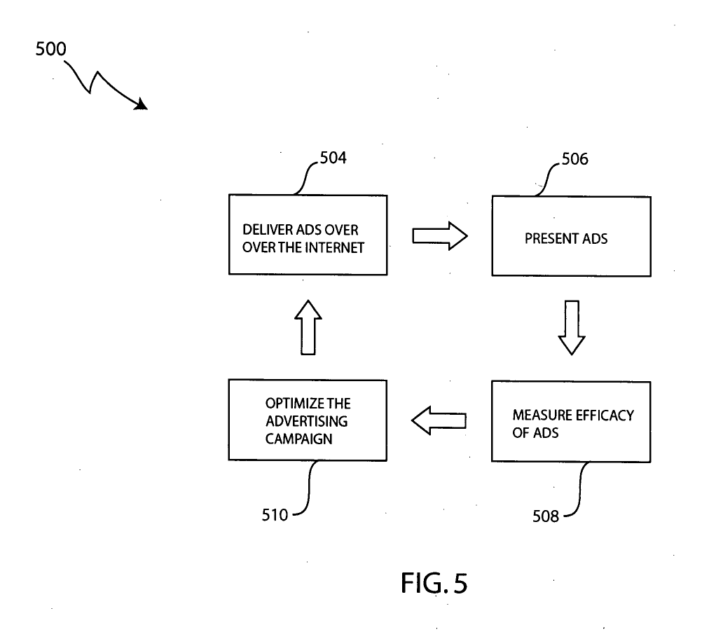

Campaign manager 145 may comprise computer-readable program code for managing an advertising campaign. Campaign manager 145 measures the efficacy of an advertising campaign and, based on the measurement, automatically optimizes the advertising campaign. In one embodiment, campaign manager 145 automatically optimizes an advertising campaign by presenting advertisements to end-users, employing conversion tracker 143 to determine the conversion rate of the advertisements, and making changes to when and how the advertisements are presented to end-users. Campaign manager 145 may continue the aforementioned optimization process until a target conversion rate has been achieved or after a predetermined amount of time, for example. This aspect of the present invention is now further discussed in connection with FIG. 5.

FIG. 5 shows a flow diagram of a method 500 of optimizing an advertising campaign on a computer network in accordance with an embodiment of the present invention. The advertising campaign may be for a single product (e.g., goods and services). Method 500 is described with reference to the components shown in FIG. 2. It should be understood, however, that the invention is not so limited and may also be implemented using other components.

In step 504, a plurality of advertisements for the same product are delivered over the Internet. The advertisements may be delivered by way of message units 141. Each advertisement may have characteristics that include aesthetic features and triggers. The aesthetic features of each advertisement may include the presentation vehicle where the advertisement is to be displayed and a message content. For example, a variety of presentation vehicles of different types (e.g., pop-up, pop-under, slider, custom window) and having different looks (e.g., different color borders) may be prepared for the advertising campaign. The presentation vehicles may then be stored in message server computer 140 or client computers 110, and specified in vehicle 343 of corresponding message units 141. This allows campaign manager 145 to choose a different presentation vehicle for an advertisement in the event the existing one is not resulting in a target conversion or click-through rate, for example.

Similarly, a variety of message contents may be prepared for the advertising campaign. For example, message contents having different artworks, sales pitches, graphics, and the like may be prepared and then specified in message content 342 of corresponding message units 141. The message contents may be stored in message server computer 140 or in an advertising server. For example, a message content 342 of a message unit 141 may include computer-readable program code to pull in a message content from the advertising server. Campaign manager 145 may thus be configured to specify a different message content in a message content 342 in the event the existing message content is not generating the desired conversion or click-through rate, for example.

Different triggers may also be prepared for the advertising campaign. The triggers may be specified in rules 344 of corresponding message units 141. The triggers may indicate when to process a message unit 141. For example, the trigger may specify to process a message unit 141 when the end-user navigates to a particular domain (e.g., bookstore.com), or specific pages of a domain (e.g., bookstore.com/novels). This allows for optimization of when an advertisement is presented to the end-user. That is, campaign manager 145 may select a different trigger for an advertisement in the event the existing trigger is not generating the desired conversion or click-through rate, for example.

In one embodiment, a set of message units 141 having different combinations of triggers, message contents, and presentation vehicles are prepared in advance for an advertising campaign. Database 142 in message server computer 140 may provide an index for the message units 141 of the advertising campaign. Campaign manager 145 may try all or several of the message units 141 to determine the best advertisement for the campaign.

In step 506, the advertisements for the advertising campaign are presented to end-users. The advertisements may be presented based on their triggers and aesthetic features specified in their respective message units 141. For example, referring to FIG. 2, an advertisement 116 may be displayed by message delivery program 120 in a presentation vehicle 115 specified in vehicle 343 of the message unit 141. The advertisement 116 may have an artwork and hyperlinks specified in message content 342 of the message unit 141. In addition, the advertisement 116 may be presented to the end-user when one or more triggers specified in rules 344 have been met.

In step 508, the efficacy of the advertisements for the advertising campaign are measured. The efficacy of an advertisement may be measured in terms of its conversion rate, for example. That is, the efficacy of an advertisement may be measured by determining the number of end-users who were shown the advertisement and actually purchased the advertised product. Conversion tracker 143 may be employed to determine the conversion rate of individual advertisements. Statistics manager 144 may present the results of conversion tracker 143 in a format that can be compared to a threshold. The conversion rate of an advertisement may be compared to the threshold to determine if the advertisement meets the goals of the advertising campaign. For example, if the advertising campaign requires advertisements with a conversion rate of at least 0.01% (i.e., 1 conversion for every 10000 impressions of the advertisement), an advertisement having a conversion rate less than 0.01% percent may have to be replaced.

Other means of measuring the efficacy of an advertisement may also be employed. For example, click-through rates may be measured instead of conversion rates. A click-through rate is a measure of the number of end-users who interacted with an advertisement (e.g., by clicking on the advertisement with a mouse) but did not necessarily converted the interaction. For example, with reference to FIG. 2, a click-through rate may be a measure of the number of end-users who reached landing web page 171 by clicking on advertisement 116, but did not necessarily reached confirmation web page 173.

In step 510, the advertising campaign is optimized. In one embodiment, the advertising campaign is optimized by changing a characteristic of an advertisement based on its efficacy (e.g., conversion, click-through). The changed characteristic may be an aesthetic feature of the advertisement. For example, if an advertisement using a first presentation vehicle has a conversion rate of 0.0001% and at least 0.003% is required by the advertising campaign, campaign manager 145 may automatically select a second presentation vehicle for the advertisement by invoking a message unit 141 that is the same as the last except for the use of the second presentation vehicle. The changed characteristic of the advertisement may also be a trigger. For example, an advertisement that is presented to end-users upon a reaching a particular web page (e.g., bookstore.com/novels) may instead be presented to end-users when they reach another web page (e.g., bookstore.com/novels/non-fiction). Campaign manager 145 may automatically select a different trigger for the advertisement by invoking a message unit 141 that is the same as the last except for the different trigger in rules 344.

As can be appreciated, the loop comprising steps 504, 506, 508, and 510 may be repeated until the advertising campaign has reached a desired optimization level (e.g., reached a target conversion or click-through rate) or after a specified amount of time (e.g., until the end of the advertising campaign). The steps may also be continually performed until all the advertisements for the advertising campaign have been tried out, and the most effective ones have been selected for delivery to end-users.

Techniques for optimizing an advertising campaign on a computer network have been disclosed. While specific embodiments of the present invention have been provided, it is to be understood that these embodiments are for illustration purposes and not limiting. Many additional embodiments will be apparent to persons of ordinary skill in the art reading this disclosure.

1. A method of optimizing an advertising campaign on a computer network, the method comprising:
delivering an advertisement to a client computer over a computer network;
automatically measuring an efficacy of the advertisement to generate a result; and
automatically changing a characteristic of the advertisement based on the result.

2. The method of claim 1 wherein the computer network includes an Internet.

3. The method of claim 1 wherein the result is based at least on a click-through of the advertisement.

4. The method of claim 1 wherein the result is based at least on a conversion of the advertisement.

5. The method of claim 1 wherein the characteristic comprises a trigger on when the advertisement is to be displayed.

6. The method of claim 1 wherein the characteristic comprises an aesthetic feature of the advertisement.

7. The method of claim 6 wherein the aesthetic feature includes a presentation vehicle for displaying the advertisement.

8. The method of claim 1 wherein the advertisement is displayed in a pop-up in the client computer.

9. The method of claim 1 wherein the advertisement is displayed in the client computer when a web browser in the client computer is pointed to a particular website.

10. The method of claim 1 wherein measuring the efficacy of the advertisement includes receiving data from a client program running and stored in the client computer, the data being indicative of an end-user response to the advertisement.

11. A computer program product comprising:
computer-readable program code configured to deliver an advertisement to a client computer over a computer network;
computer-readable program code configured to automatically measure an efficacy of the advertisement; and
computer-readable program code configured to automatically change a characteristic of the advertisement based on a measurement of an efficacy of the advertisement.

12. The computer program product of claim 11 wherein the characteristic comprises a trigger on when to display the advertisement in the client computer.

13. The computer program product of claim 11 wherein the characteristic comprises an aesthetic feature of the advertisement.

14. The computer program product of claim 11 wherein the efficacy is based on a click-through of the advertisement.

15. The computer program product of claim 11 wherein the efficacy is based on a conversion of the advertisement.

16. A method of delivering advertisements over a computer network, the method comprising:
delivering a first advertisement of an advertising campaign to a client computer;
receiving data from a client program running and stored in the client computer, the data being indicative of a user response to the first advertisement;
determining an efficacy of the first advertisement based at least on information including the user response to the first advertisement; and
delivering a second advertisement of the advertising campaign to another client computer, the second advertisement being automatically selected based on the efficacy of the first advertisement.

17. The method of claim 16 wherein the efficacy relates to a click-through of the first advertisement.

18. The method of claim 16 wherein the efficacy relates to a conversion of the first advertisement.

19. The method of claim 16 wherein the first advertisement is delivered over an Internet.

20. The method of claim 16 wherein the first advertisement and the second advertisement are for a same product and have different presentation vehicles.

21. The method of claim 15 wherein the first advertisement and the second advertisement are for a same product and have different processing triggers.

22. A method of optimizing an advertising campaign, the method comprising:
delivering a plurality of advertisements for a same product to a plurality of client computers;
receiving data from client programs running and stored in the client computers;
determining an efficacy of each of the advertisements based on the received data; and
automatically selecting an advertisement for the product based on the efficacy of the advertisements.
